(19) United States
(12) Patent Application Publication
(10) Pub. No.: US 2007/0221579 A1
(43) Pub. Date: Sep. 27, 2007

(54) Methods and systems for reducing the transport of contaminants in groundwater

(76) Inventors: Alan D. Wilks, Mount Prospect, IL (US); Kenneth F. Packer, Naperville, IL (US); Daniel Grant Greene, Ada, MI (US)

Correspondence Address: BERENATO, WHITE & STAVISH, LLC, 6550 ROCK SPRING DRIVE, SUITE 240, BETHESDA, MD, 20817, US

(21) Appl. No.: 11/723,521

(22) Filed: Mar. 20, 2007

Related U.S. Application Data
(60) Provisional application No. 60/783,849, filed on Mar. 21, 2006.

(51) Int. Cl. C02F 1/52

(52) U.S. Cl. 210/702; 210/747; 210/170.07

(57) ABSTRACT

Methods for reducing the transport of contaminants in groundwater and methods for reducing the contamination of groundwater are disclosed. The methods may include adding a reagent to groundwater and contacting a contaminant with the reagent to form a precipitate and compiling the precipitate to form a barrier to groundwater flow. Systems for reducing the transport of contaminants in groundwater including an arrangement for adding a reagent to a groundwater flow path and a formed barrier comprising contaminant precipitate in the groundwater flow path are also disclosed.

### CROSS-REFERENCE TO RELATED PATENT APPLICATIONS

This patent application claims the benefit of U.S. Provisional Patent Application No. 60/783,849, filed Mar. 21, 2006, which is hereby incorporated by reference in its entirety.

### FIELD OF THE INVENTION

The present disclosure relates to methods and systems which reduce the transport of contaminants in groundwater. In particular, the methods and systems of the present disclosure relate to forming and compiling a precipitate of a contaminant to create a barrier to groundwater flow.

### BACKGROUND OF THE INVENTION

It is well recognized that past human usage of many land areas has led to environmental contamination of these areas. For example, past practices at many manufacturing facilities led to the deposit of waste materials that may leach objectionable contaminants into groundwater, such as flowing underground aquifers. These contaminants then migrate with the groundwater creating large areas of contamination and large volumes of contaminated water. The local and regional impact of these situations can be very serious, and regulations now exist that force remediation efforts to be undertaken.

A variety of remediation techniques are known. Unfortunately, many of these options are undesirable for various reasons. For example, while excavation is a possible option, it is prohibitively expensive in many cases, in particular, in situations involving large areas of contamination. Trenching and filling operations to block effluent flow, and the installation of a water treatment facility with extraction and injection wells on either side of the blockade is another similarly expensive option. Additional drawbacks to this option include the risk of a breakout of the contaminated flow in a new direction, i.e., around the blockade, and the continuing presence of the contaminated soil which is treated only by continual elution over a long period of time. Furthermore, many treatment processes address only a single contaminant or single type of contaminant, e.g., only dissolved or only suspended contaminants, and therefore multiple treatment processes are often necessary to achieve a desired water quality.

### SUMMARY OF THE INVENTION

In accordance with one embodiment, a method of reducing the transport of contaminants in groundwater that contacts a source of contaminants comprises adding a reagent to the groundwater, contacting a contaminant with the reagent to form a precipitate, and compiling the precipitate to form a barrier to groundwater flow.

In accordance with another embodiment, a method of reducing contamination of groundwater comprises restricting a flow of groundwater into a contaminated area by precipitating a contaminant and compiling the precipitate in a groundwater flow path into the contaminated area to form a barrier to groundwater flow into the contaminated area.

In accordance with yet another embodiment, a system for reducing the transport of contaminants in groundwater comprises an arrangement for adding a reagent to a groundwater flow path, and a formed barrier comprising contaminant precipitate in the groundwater flow path.

Embodiments of the presently disclosed methods and systems may provide numerous advantages in the field of groundwater contamination remediation. The present disclosure provides an effective, economical, and long-term solution to the problem of groundwater contamination from contact with contaminated land areas. The presently disclosed methods and systems not only prevent or reduce the transport of contaminants away from a contaminated area, but in many embodiments may prevent or reduce the amount of groundwater coming into contact with a contaminated site. Additionally, the presently disclosed methods and systems minimize or eliminate the transport of contaminants while avoiding the need to treat all of the contaminant material in a contaminated land area. Advantageously, in accordance with the present disclosure, the need for continual long-term water treatment and complex processing to remove a multiplicity of contaminants may be avoided. In some embodiments, the presently disclosed methods may also reduce carbon dioxide emissions into the atmosphere.

### DESCRIPTION OF EMBODIMENTS

An embodiment of the present disclosure is directed to reducing the transport of contaminants in groundwater that contacts a source of contaminants. The source of contaminants may comprise a porous or permeable mass of contaminants, e.g., a collection of particulate contaminant material, through which water can migrate. Groundwater may comprise any water beneath the ground surface and may include water in an underground aquifer and/or water, such as rainwater or other water, which has filtered through the ground. Groundwater typically exists in the form of water saturating the pore spaces in permeable rock and/or the spaces between particles of unconsolidated material, e.g., between particles of gravel, silt, sand or clay. Thus, groundwater flow paths may comprise passageways between interconnecting pores in permeable rock and/or between and around particles of unconsolidated material. Groundwater flow paths through a source of contaminants, e.g., through passageways between contaminant particles may introduce contaminants into the groundwater. The groundwater may carry, e.g., transport, the contaminants along the flow path and away from the contaminated area.

Embodiments of the present method may comprise adding a reagent to the groundwater and contacting a contaminant with the reagent to form a precipitate. Typically, the formation of a precipitate, i.e., the formation of a solid from a solution, is the result of a chemical reaction. In the present method, the reagent and contaminant may come into contact and react with one another to form a precipitate. For example, the reagent may dissociate in water to form an ionic compound (i.e., a mixture of cations and anions) and the contaminant may similarly be present in the groundwater in the form of an ionic compound. When the cations or anions of the reagent encounter the contaminant anions or cations, respectively, the ions may react and form a precipitate.

In a laboratory environment, a precipitate generally “falls” out of the solute phase and sinks to the bottom of the solution as a separate phase. In the present method, the reagent and contaminant may form a precipitate which may “fall” out of the groundwater and sink to the bottom of the groundwater flow path. For example, the precipitate may “fall” out of the groundwater flowing through the pores or spaces between and around the contaminant particulates. As precipitate is formed and “falls” out of the groundwater, it may be compiled, e.g., it may accumulate, in the flow path. The compilation of the precipitate in a flow path is similar to the clogging of a filter, with the precipitate “clogging” the pores or spaces between particles of contaminant comprising the flow path. The compiled precipitate thus forms a restrictive barrier to groundwater flowing along the flow path. For example, as the quantity of precipitate compiled in the flow path increases, the flow may be increasingly restricted along the groundwater flow path. Thus, a barrier comprising the contaminant precipitate may be “built-up” in a groundwater flow path to restrict the flow of contaminated groundwater along the flow path. A formed barrier may restrict, but need not completely prevent, flow along the flow path. Rather, the barrier may reduce the porosity and/or permeability of the contaminated area and increase the propensity of the flow to bypass the area. As an additional advantage, the compilation of the precipitate may reduce the transport of suspended contaminants through and away from the contaminated area; the “clogged” pores may operate to trap and/or filter suspended contaminants in the groundwater. These trapped suspended contaminants may further reduce the porosity or permeability of the contaminated area, further increasing the tendency of the groundwater to bypass the area.

Reagent may be added to the groundwater at any of a number of locations and in a variety of forms. In many embodiments, the reagent may be added to groundwater that does not include the contaminant. For example, in some embodiments, a liquid or gaseous reagent may be added to groundwater at one or more locations upstream or upgradient of the contamination site. The reagent may be injected directly into the source of groundwater and/or the groundwater may be removed from the source, injected with reagent, and then returned to the source. In many embodiments, the natural flow of the groundwater will carry the reagent into contact with the contaminant. However, in some embodiments, reagent containing water may be injected into the groundwater to change the natural flow of the groundwater to increase the contact of the reagent and contaminant. Additionally or alternatively, a gaseous reagent may be added to groundwater in one or more locations below the source of contamination. The reagent gas will migrate upward (and to an extent outward in the form of a cone) into contact with the contaminant.

The precipitate may be formed and compiled at various locations, and in some embodiments, precipitate may be formed and compiled at multiple locations. For example, the precipitate may be formed and compiled at locations to restrict the flow of contaminated groundwater through the source of contaminants and/or to prevent the flow of groundwater into the source of contaminants. In some embodiments, the precipitate may be formed and compiled within the contaminated area, e.g., in the voids or spaces between the particulates comprising the contaminated area. Additionally or alternatively, the precipitate may be formed and compiled at a periphery of the contamination source, e.g., in pores, spaces or voids formed between uncontaminated material and adjacent contaminated material. For example, the periphery of the contamination source may comprise an edge or boundary region of the contaminated area where the reagent encounters a contaminant.

In many embodiments, compiling the precipitate and forming barrier(s) may effectively isolate the contamination source from the groundwater. For example, forming a barrier, e.g., a restrictive barrier, in a groundwater flow path will often cause the groundwater to divert and find a new flow path, e.g., a path with lower flow resistance. In some cases, the new flow path will contact the contaminated area. In many embodiments, reagent will be present in the groundwater flowing along the new flow path and will contact a contaminant, and form a precipitate. As barriers continue to be formed in new flow paths contacting the contaminated area, the contaminated area may effectively become “encapsulated”, e.g., the permeability or porosity of the contaminated area may be reduced to such a degree that flow through the area is substantially reduced and contaminant concentrations are within acceptable limits. Advantageously, by effectively encapsulating the contaminated area, the need for long-term continual treatment at the site and multiple treatment processes to address the multitude of contaminants which may be present in the contaminated area may be avoided.

Numerous sources of groundwater contamination exist. These sources may include deposits of various materials which introduce dissolved and/or suspended contaminants into the groundwater. Contaminants may be introduced into groundwater flowing through the contaminated area, e.g., flowing through the spaces or voids between the particles of contamination, or flowing along a periphery of and in contact with the contaminated area. An exemplary source of contamination is cement kiln dust, which is a by-product of Portland cement manufacturing. The cement kiln dust is a mixture of partially calcined and un-reacted raw limestone feed, clinker dust, and fuel ash, enriched with alkalis, sulfates, halides, and other inorganic and organic materials. This source of contamination results in the presence of calcium, magnesium, aluminum, iron, sulfate, chloride, potassium, and/or sodium, often in the form of hydroxides, in the groundwater. Cement kiln dust contamination may also result in the presence of arsenic, barium, chromium, copper, lead, mercury, nickel, selenium, silver, thallium, vanadium, and zinc in the groundwater as leachate from the deposit. Other sources of contamination may result in the presence of some or all of the above contaminants, as well as other contaminants. The invention is not intended to be limited by the particular contaminants in the groundwater. Rather, the identification of some exemplary contaminants is provided to facilitate an understanding of the selection of suitable reagents and advantages of the invention.

A wide variety of reagents may be utilized and the selection of a particular reagent may depend on a number of factors. The reagent is preferably capable of dissociating in water to provide the ions to precipitate at least one dissolved contaminant. Therefore, the chemistry of the contaminant and its ability to form a precipitate is a primary factor in the selection of reagent. Solubilities of common ionic compounds are well documented, and thus the selection of a reagent which will precipitate a particular contaminant is well within the ordinary skill of those in the field. However, the chemistry and ability to precipitate a contaminant is not the only factor to consider. The reagent itself and/or any by-products of the precipitation reaction should be innocuous, and preferably not introduce any new objectionable contaminants into the groundwater. Cost, availability, ease of handling, and other such factors may also affect the selection of a reagent.

Exemplary reagents may include ionic compounds which dissociate in water to provide carbonate, sulfide, sulfite, sulfate, and phosphate ions. For example, in an exemplary embodiment wherein the source of contamination is calcium rich and the effluent groundwater pH is high, a preferred reagent may comprise gaseous carbon dioxide. Calcium rich contamination sites often result in the presence of calcium hydroxide in the groundwater, often evidenced by the discovery of groundwater having a high pH. The gaseous carbon dioxide, when injected into water, dissolves to form carbonic acid, which under certain conditions, reacts with the calcium hydroxide to form calcium carbonate, as shown in Equations 1 and 2 below.

CO_{2(g)}+H₂O₍₁₎ [symbol] H₂Co_{3(aq)} (1)

H₂CO_{3(aq)}+Ca(OH)_{2(aq)}→CaCO₃₍ₛ₎+2H₂O₍₁₎ (2)

In many embodiments, the reaction of carbonic acid and calcium hydroxide is effected in groundwater having a high pH, e.g., a pH greater than or equal to about 9, since the reaction is particularly effective in forming the carbonate salt at higher pH values, versus the bicarbonate salt, which may be formed at lower pH values, e.g., a pH lower than about 9. Forming the carbonate salt is preferred in most embodiments since the carbonate salt is less soluble than the bicarbonate material. Carbon dioxide is a particularly advantageous reagent in many embodiments for numerous reasons. For example, the carbonic acid which is formed when carbon dioxide is dissolved in water comprises a weak acid and the precipitation reaction between the carbonic acid and contaminant hydroxide produces no contaminating by-products.

In another exemplary embodiment, the reagent may comprise phosphoric acid. For example, certain oxides will react with phosphate ions to form products which are highly insoluble, adherent, and which demonstrate relatively high stabilities in contact with aqueous media. In particular, oxides of beryllium, zinc, copper, magnesium, bismuth, cadmium, tin, lead, and cobalt will form cementitious precipitates under certain conditions. For example, cementitious metal phosphate precipitates may form in environments where the oxide is sufficiently soluble to react with the phosphate ions to form a precipitate. These phosphate precipitates exhibit exceptional stability and persistence in the presence of moisture and a variety of different force loadings. Advantageously, the cementitious property of a precipitate may provide an additional mechanism for affixing and immobilizing the precipitate in the groundwater flow path.

Other exemplary reagents may also include hydrogen sulfide (or ammonium polysulfide) to provide sulfide ions, sulfur dioxide or sulfurous acid to provide sulfite ions, and sulfuric acid to provide sulfate ions. In some embodiments, the reagent may comprise a compound which dissociates to provide carbonate ions, for example, sodium carbonate or bicarbonate. Carbonate ions may react with oxides to form carboxylic acid-based cemetititious precipitates similar to the cementitious phosphate precipitates.

Reagents may be available from a variety of sources, and suitable reagents are commercially available. In some embodiments, the reagent may be recovered from an industrial or manufacturing process stream. For example, carbon dioxide may be recovered from the effluent from a large fossil fueled facility, such as a power plant or large boiler. The recovered carbon dioxide may be piped directly from a facility to a contaminated site or may be otherwise transported. Advantageously, utilizing recovered reagents may reduce remediation costs and, in the case of recovered carbon dioxide, reduce emissions of greenhouse gases into the atmosphere.

Various reagent concentrations may be utilized to precipitate a solubilized contaminant, and the specific concentration will depend on the chemistry of the reagent and contaminant and the concentration of contaminant in the groundwater. Specifically, a theoretical reagent concentration may be calculated based on the solubility constant for the desired precipitate, the contaminant concentration in the groundwater, and stoichiometry of the reagent and contaminant. For example, for groundwater having a calcium ion concentration of about 17 mg/L, about 10 to about 12 cm³ of carbon dioxide (at STP) will theoretically precipitate about 99.9% of the calcium ions present in a liter of such solution. This corresponds to about 21 mg of carbon dioxide for each liter treated. The determination of the theoretical reagent concentration to precipitate a particular contaminant is well within the ordinary skill of those in the field having reference to this disclosure.

In application, the actual reagent titer needed to precipitate the contaminant may differ from the theoretical concentration, for example, due to inefficiencies associated with fluid transfer or reaction with other co-present ions. The actual amount of reagent to be added may be determined by making adjustments to the theoretical value, for example, by incrementally increasing the reagent concentration over the theoretical value, until the desired precipitation is effected. Additional adjustments may also be necessary, for example, to correct for fluctuations or changes in groundwater flow rates.

In many applications, reagent concentrations may be optimized by periodically or continuously monitoring water quality downstream of the site where the reagent is introduced. In some embodiments, it may be beneficial to monitor the pH value of the water, reagent concentration, and/or contaminant levels downstream of the contaminated area. For example, elevated reagent levels may indicate the addition of excess reagent, while the presence of unprecipitated contaminant may indicate the addition of too little reagent. Elevated pH values and/or the presence of contaminants downstream of the contaminated area may indicate that the groundwater is still contacting the contaminated area and therefore, the addition of reagent should continue. In contrast, neutral pH values and the absence of contaminants downstream of the site may indicate that the groundwater is no longer contacting the contaminated area, and the addition of reagent may be reduced or halted. Accordingly, by monitoring one or more downstream parameters, reagent levels may be maintained at effective levels and the use of excess reagent may be avoided.

In many embodiments, after reducing or halting the addition of reagent, it may be beneficial to continue or implement periodic or continuous monitoring of water quality downstream of the barrier. Downstream water quality monitoring may provide early identification of a breach in a barrier. For example, if groundwater in the flow path breaks through a portion of a barrier and contacts the contaminated area, elevated pH levels and/or the presence of contaminants in the downstream groundwater will facilitate detection of the breach. Advantageously, the presently disclosed method allows for easy repair of a barrier breach, by resuming addition of the reagent to form a precipitate and compile the precipitate to close the breach.

In some embodiments, it may be advantageous to utilize one or more additional groundwater treatments, upstream or downstream of the contaminated area. For example, during the formation of a barrier, e.g., at a time when a first reagent is being added and a precipitate is being formed and compiled, but groundwater has not yet been prevented from contacting the contaminated area, contaminants may be reduced, but may not be prevented from being transported in the groundwater. It may therefore be beneficial to treat the groundwater downstream of the contaminant area in one or more ways. For example, one or more additional reagents may be added to the groundwater. Additional reagents may comprise reagents different from the first reagent and may be added in the same location as the first reagent or upstream or downstream of where the first reagent is introduced. In some embodiments, an additional reagent may comprise the same reagent as the first reagent and may be added downstream of where the first reagent is added. For example, in an embodiment, carbon dioxide may comprise the first reagent and the precipitate may be formed in groundwater having a pH at or above about 9. After precipitation, the groundwater pH remains undesirably high, and carbon dioxide, as an additional reagent, may be added downstream of the contamination area to reduce the pH level of the groundwater. Reducing the pH level may also have the added benefit of reducing levels of dissolved metal contaminants due to adsorption and other natural attenuation mechanisms.

Methods in accordance with the present disclosure provide an effective, long-term solution to the problem of groundwater contamination. The present methods may reduce the porosity or permeability of the contaminated area and/or the flow through the contaminated area, without reacting or treating all of the reactive contaminant material in the area. Advantageously, by forming barriers to flow into and through the contaminated area, the source of contaminants may be effectively encapsulated, preventing contaminants from entering and being spread by the groundwater. Thus, the need for costly continual long-term treatment or removal of the contaminant source may be avoided. Additionally, the present methods minimize the risk or harm from break-outs of flow in a new direction, by forming a barrier that may be easily and effectively repaired or replaced by resuming addition of the reagent and forming a contaminant precipitate barrier in the location of the break-out.

Systems, in accordance with the present disclosure, for reducing the transport of contaminants in groundwater may have a variety of configurations. An exemplary system may comprise an arrangement for adding a reagent to groundwater flowing along a flow path, and a formed barrier comprising contaminant precipitate in the groundwater flow path. A contaminant precipitate barrier may be formed by precipitating a dissolved contaminant by contact with a reagent and causing the precipitate to compile, e.g., accumulate or build-up, into a formed barrier in the groundwater flow path.

The arrangement and the formed barrier may be variously located with respect to the contaminated area. In many embodiments, the arrangement may be disposed upstream of the contaminated area and the barrier may be located downstream of the arrangement. Upstream of the contaminated area may include any area in which groundwater flow, e.g., natural or forced, is in a direction from the arrangement to the contaminated area. Disposing the arrangement upstream of the contaminated area may advantageously avoid the formation of precipitate at the arrangement, which may lead to a blockage of the arrangement. For example, by disposing the arrangement upstream of the source of contaminants, the reagent is added to uncontaminated water, and no precipitate is formed until the reagent travels downstream and contacts the contaminant. Thus, the barrier may be advantageously formed downstream of the arrangement and the risk of blocking the arrangement with precipitate may be avoided. In some embodiments, the arrangement may be disposed below the contaminated area. For example, the arrangement may introduce a gaseous reagent into water below the contaminated area and the reagent may rise upwardly and outwardly until it contacts the source of contamination and forms the precipitate.

In some embodiments, the system may include more than one arrangement. For example, the system may include one or more arrangements upstream of the contaminated area and/or one or more arrangements below the contaminated area. A variety of combinations of arrangements may be utilized to optimize barrier formation and the encapsulation of the contaminated area.

A formed barrier may comprise any compilation, e.g., accumulation, of precipitate that restricts flow along a flow path. The barrier may be variously located to restrict groundwater flow into or out of the contaminated area and minimize the transport of contaminants away from the contaminated area. For example, formed barriers may be located at a periphery of the contaminated area and/or within the contaminated area and may comprise an accumulation of precipitate in the pores or spaces between contaminant particles. In some embodiments, the formed barrier may comprise one or more formed barriers. For example, compilations of precipitate may be located in various flow paths in the contaminant area to reduce the porosity or permeability and restrict flow into the contaminated area.

Arrangements in accordance with the present disclosure may have any of a multitude of configurations. For example, arrangements may include a source of reagent and an assembly for introducing a reagent into the groundwater. An exemplary source of reagent may comprise a tank or other vessel containing reagent which is fluidly connected to an assembly for introducing reagent. In some embodiments, the source of reagent may comprise a waste stream or by-product from an industrial or manufacturing process stream, which may be piped directly to and fluidly connected with the assembly.

An assembly for introducing the reagent into the groundwater may include any of numerous assemblies capable of introducing a reagent directly or indirectly into a source of groundwater. For example, the assembly may comprise an apparatus such as a nozzle, pipe, tube, or other line fluidly connected to the source of reagent which discharges directly into the source of groundwater. In embodiments utilizing a gas reagent, the apparatus may comprise a sparger, for bubbling gas into the groundwater. In some embodiments, the apparatus may not discharge directly into the source of groundwater and the assembly may further comprise a well or other system for withdrawing water from the ground. For example, an assembly may comprise one or more horizontal wells, vertical wells, horizontal sparge systems, vertical sparge wells, vertical or horizontal re-circulation wells, and/or any combination thereof. A well may withdraw groundwater from the ground and a sparger, nozzle or other apparatus may introduce the reagent into the withdrawn groundwater. In some embodiments, the reagent may be combined with water from a separate source and the combination may be added to the groundwater. Once the reagent has been added to the withdrawn groundwater, the groundwater may be returned to the ground, e.g., at, near or downstream of the well location. In some embodiments, injection wells may be used to increase the groundwater flow in and adjacent to the contaminated area, for example, to increase the rate of precipitation. In other embodiments, recirculation wells or systems, e.g., a combination of injection wells and removal wells may be used to introduce reagent into the groundwater without increasing the total amount of groundwater flowing in the area. Additionally, the combined effect of adding reagent containing groundwater to the groundwater source and groundwater removal wells may improve the distribution of reagent in the groundwater that contacts the contaminated area, and may reduce the number of addition points used to effectively treat the contaminated area. Furthermore, the flow direction through recirculation systems can be reversed, as needed, to better control and deliver carbon dioxide containing groundwater to the contaminated area.

The presently disclosed systems provide a simple, economical and effective solution to the problem of contaminated groundwater caused by contact with contaminated land areas. The systems utilize an innocuous, stable, and easily formed barrier to groundwater flow, which reduces or prevents groundwater flow into contaminated areas and/or reduces or prevents contaminated groundwater flow away from contaminated areas. Preventing contamination of the groundwater avoids the need for costly and complex treatment to clean-up the contaminated water. As another advantage, a barrier formed from precipitated contaminants minimizes system costs by reducing labor and material costs associated with barrier building.

All references including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of the describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. Recitation of ranges of values herein are merely intended to serve as a shorthand method of referring individually to each separate value falling with the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of reducing the transport of contaminants in groundwater that contacts a source of contaminants comprising:
adding a reagent to groundwater;
contacting a contaminant with the reagent to form a precipitate; and
compiling the precipitate to form a barrier to groundwater flow.

2. The method of claim 1, wherein the groundwater to which the reagent is added is substantially free of the contaminant.

3. The method of claim 1, wherein the barrier to groundwater flow reduces the porosity and/or permeability of the source of contaminants.

4. The method of claim 1, wherein contacting a contaminant comprises contacting a dissolved contaminant.

5. The method of claim 1, wherein the reagent comprises a gas and/or a liquid selected from carbon dioxide, phosphoric acid, hydrogen sulfide, ammonium polysulfide, sulfur dioxide, sulfurous acid, sulfuric acid, sodium carbonate, sodium bicarbonate, and mixtures thereof.

6. The method of claim 1, wherein the contaminant comprises a metal and/or inorganic compound.

7. The method of claim 6, wherein the contaminant comprises one or more of calcium, magnesium, aluminum, iron, sulfate, chloride, potassium, sodium, arsenic, barium, cadmium, chromium, copper, lead, mercury, nickel, selenium, silver, thallium, vanadium.

8. The method of claim 1, wherein the reagent comprises a first reagent and the method further comprises adding a second reagent to the groundwater, wherein the second reagent may be the same as or different from the first reagent.

9. The method of claim 8, wherein the second reagent is added downstream of the first reagent.

10. A method of reducing the contamination of groundwater comprising restricting a flow of groundwater into a contaminated area by precipitating a contaminant and compiling the precipitate in a groundwater flow path into the contaminated area to form a barrier to groundwater flow into the contaminated area.

11. The method of claim 10, wherein precipitating a contaminant comprises adding a reagent to the groundwater and contacting a dissolved contaminant with the reagent to form the contaminant precipitate.

12. The method of claim 10, wherein the barrier comprises more than one barrier.

13. The method of claim 10, wherein the barrier reduces the porosity and/or permeability of the contaminated area.

14. A system for reducing the transport of contaminants in groundwater which contacts a source of contaminants comprising:
an arrangement for adding a reagent to groundwater flowing along a flow path, and
a formed barrier comprising contaminant precipitate in the groundwater flow path downstream of the arrangement.

15. The system of claim 14, wherein the arrangement is disposed upstream of the source of contaminants.

16. The system of claim 14, wherein the arrangement includes a source of the reagent and a horizontal well, a vertical well, a horizontal sparge system, a vertical sparge point, a vertical sparge well, a vertical recirculation well and/or any combination thereof.

17. The system of claim 16, wherein the arrangement includes a recirculation system.

18. The system of claim 14, wherein the formed barrier comprises a plurality of formed barriers.

19. The system of claim 14, wherein the formed barrier comprises calcium carbonate.

20. The system of claim 14, wherein the formed barrier comprises a phosphate precipitate or a carboxylic-acid based precipitate.
